(19) United States
(12) Patent Application Publication
(10) Pub. No.: US 2022/0348152 A1
(43) Pub. Date: Nov. 3, 2022

(54) Slide-Topper Anti-Flapping and Noise Silencer Device

(71) Applicants: Tim Loynd, Rapid City, SD (US); Dora Loynd, Rapid City, SD (US)

(72) Inventors: Tim Loynd, Rapid City, SD (US); Dora Loynd, Rapid City, SD (US)

(21) Appl. No.: 17/529,853

(22) Filed: Nov. 18, 2021

Related U.S. Application Data
(60) Provisional application No. 63/180,873, filed on Apr. 28, 2021.

(51) Int. Cl. B60R 13/08; B60J 3/00; B60J 3/02; B60R 13/04

(52) U.S. Cl. CPC B60R 13/0884; B60J 3/002; B60J 3/0234; B60R 13/04; B60R 2013/0807

(57) ABSTRACT

The present invention relates to a slide-topper anti-flapping and noise silencer device. The anti-flapping device features a folding hinge-like component and a pair of spring clamps. The folding hinge-like component has a pivotally connected rectangular upper panel and rectangular lower panel. The folding hinge-like component is secured along a leading edge of a slide-topper with the upper panel adhered to the top surface of the slide-topper and the lower panel adhered to the bottom surface of the slide-topper. Spring clamps are then used to secure the upper panel and the lower panel to the slide-topper. The anti-flapping device secures and stabilizes the leading edge of the slide-topper to eliminate flapping and any other associated noises.

### CROSS-REFERENCE TO RELATED APPLICATION

The present application claims priority to, and the benefit of, U.S. Provisional Application No. 63/180,873, which was filed on Apr. 28, 2021 and is incorporated herein by reference in its entirety.

### FIELD OF THE INVENTION

The present invention relates generally to the field of recreational vehicles. More specifically, the present invention relates to a slide-topper noise-eliminating device designed to be attached to the leading edges of the slide-topper to firmly secure its edges and drastically reduce the vibration and noise caused by high winds. The slide-topper noise eliminating device comprises a folding hinge-like component that is secured to the topper by two friction slide clamps. Further, the device features rubber grips on the interior surface of the folding hinge-like component which act to securely hold the slide-topper device in place. Additionally, the slide-topper noise-eliminating device features a ribbed design to allow for easy water drainage during storms. The slide-topper noise eliminating device can be easily used with any conventional slide-topper on recreational vehicles, travel trailers, fifth wheel trailers, etc. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, recreational vehicles (RVs), travel trailers, fifth wheel trailers, etc., are used by people for recreational purposes such as camping, and more. Generally, families travelling together for vacation utilize RVs. Typically, the recreational vehicles include an RV slide out or slide which is a cut-out portion of the recreational vehicle that extends and retracts to increase the living space provided by the vehicle. The slide out is moved between an extended position and a retracted position via a hydraulic, electrical, and/or manual mechanical system. A slide-topper or slide out awning is also used with the RVs slide outs to cover the roof of the slide out and protect it from rain and/or debris. Generally, the slide-topper is made of a durable vinyl fabric sheet that is connected to a reel which extends and retracts automatically over an RV slide out room.

While the recreational vehicle is moving, with the slide out in extended position, the slide-toppers face high winds that cause the thin sheet of slide-topper to flap and bang, and thereby create an incredibly noisy environment inside the living compartment of the vehicle. Users travelling in the vehicle may be uncomfortable in such noisy environment, and one may not be able to fully enjoy travelling in these vehicles. Additionally, the slide-topper may be torn in such extreme windy conditions. Further, the standard slide-topper may not be able to survive the buffeting of winds and the topper spring can damage easily. Thus, users may be required to frequently get their slide-toppers repaired or replaced in order to maintain their recreational vehicles. This increases the vehicle maintenance expenses for vehicle owners.

Therefore, there exists a long felt need in the art for a device that can be easily attached to slide-toppers in order to keep the topper sheet in place in windy conditions. There is also a long felt need in the art for a device that prevents the slide-toppers from flapping or banging in windy conditions. Additionally, there is a long felt need in the art for a slide-topper noise-eliminating device that ensures that the slide-topper does not move in strong winds and does not create a noisy environment inside the vessel. Moreover, there is a long felt need in the art for a slide-topper noise-eliminating device that provides a comfortable travelling experience for the users travelling in recreational vehicles. Further, there is a long felt need in the art for a slide-topper noise-eliminating device that prevents the slide-topper fabric from being torn and prevents the topper spring from being damaged in extremely windy conditions. Furthermore, there is a long felt need in the art for a slide-topper noise-eliminating device that does not require the user to frequently get their slide-topper repaired or replaced, and therefore reduces the vehicle maintenance expenses for vehicle owners. Finally, there is a long felt need in the art for a slide-topper noise eliminating device that can be easily fitted onto the slide-topper of any recreational vehicle with very little set up.

The subject matter disclosed and claimed herein, in one embodiment thereof, comprises a slide-topper anti-flapping device. The anti-flapping device eliminates the flapping and associated noise of a slide-topper during strong winds. More specifically, the anti-flapping device comprises a folding, hinge-like component and a pair of spring clamps. The folding, hinge-like component has a rectangular upper panel and a rectangular lower panel wherein the upper panel and the lower panel are pivotally connected along a common longitudinal line by at least one hinge. The folding, hinge-like component is secured along a leading edge of the slide-topper with the spring clamps securing the upper panel and the lower panel with the slide-topper between them. The anti-flapping device secures the leading edges of the lightweight slide-topper to eliminate flapping and associated noise.

In this manner, the novel slide-topper noise-eliminating device of the present invention accomplishes all of the forgoing objectives, and provides a relatively safe and convenient solution to ensure the slide-topper remains in place and does not flap/bang in strong winds. The slide-topper noise-eliminating device of the present invention is also user-friendly, as it can be easily clipped onto any conventional slide-topper for a RV, fifth wheel trailer, etc. Additionally, the slide-topper noise-eliminating device enhances the overall travelling experience for users, as it prevents conventional slide-toppers from creating a noisy environment during high winds.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a slide-topper anti-flapping device. The anti-flapping device is configured to eliminate flapping of a slide-topper in strong winds. The anti-flapping device comprises a folding, hinge-like component and a pair of spring clamps, wherein the folding, hinge-like component comprises a rectangular upper panel and a rectangular lower panel wherein the upper panel and the lower panel are pivotally connected along a common longitudinal line by at least one hinge. Further, the folding, hinge-like component is secured along a leading edge of the slide-topper with the upper panel adhered to the top surface of the slide-topper and the lower panel adhered to bottom surface of the slide-topper via the pair of spring clamps. Specifically, the spring clamps secure the slide-topper between the upper panel and the lower panel of the folding, hinge-like component. Thus, the anti-flapping device provides support to the lightweight slide-topper material and eliminates flapping and other associated noises.

In yet another embodiment of the present invention, a slide-topper silencer device is disclosed. The slide-topper silencer device comprises one folding hinge-like component and two friction slide clamps. The folding hinge-like component is secured to a lateral edge of the slide-topper by two friction slide clamps. The folding hinge-like component comprises pivotally-connected telescoping panels that secure the slide-topper between the panels wherein the telescoping panels can be extended or retracted to fit slide-toppers of various dimensions using the built-in telescoping slots.

In yet a further embodiment of the present invention, the anti-flapping or noise silencer device can be attached to the slide-topper of any conventional recreational vehicle, travel trailer, and/or fifth wheel. The device secures and stabilizes the edges of the slide-topper and drastically reduces the vibration and noise of slide-toppers caused by high winds. The device can fit any conventional slide-topper that is properly adjusted and in good condition.

In yet another embodiment of the present invention, an anti-billowing kit for a slide-topper and awning is disclosed. The anti-billowing kit is configured to prevent flapping, billowing and/or noise from slide-toppers and/or awnings due to strong winds. The kit comprises a folding hinge-like component that is secured to a slide-topper and/or awning and two friction slide clamps. The folding hinge-like component has rubber grips and a ribbed design to allow for water drainage from the slide-topper and/or awning. The folding hinge-like component is then secured using said friction slide clamps.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a slide-topper anti-billowing device of the present invention in accordance with the disclosed architecture;

FIG. 2 illustrates a rear perspective view of one potential embodiment of the slide-topper anti-flapping device of the present invention in accordance with the disclosed architecture;

FIG. 3 illustrates a perspective view of one potential embodiment of the slide-topper supported by the anti-flapping device of the present invention in accordance with the disclosed architecture;

FIG. 4 illustrates a front perspective view showing an installation of one potential embodiment of the anti-flapping device of the present invention on a slide-topper of a recreational vehicle in accordance with the disclosed architecture;

FIG. 5 illustrates a close-up perspective view of one potential embodiment of the anti-flapping device of the present invention installed along a leading edge of the slide-topper in accordance with the disclosed architecture; and

FIG. 6 illustrates a perspective view of another potential embodiment of the folding hinge-like component of the anti-flapping device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that can be easily attached to slide-toppers in order to keep the topper sheet in place. There is also a long felt need in the art for a device that prevents the slide-toppers from flapping or banging in windy conditions. Additionally, there is a long felt need in the art for a slide-topper noise-eliminating device that ensures the slide-topper does not move in strong winds and does not create a noisy environment inside the vehicle. Moreover, there is a long felt need in the art for a slide-topper noise-eliminating device that provides a comfortable travelling experience for users travelling in the recreational vehicles. Further, there is a long felt need in the art for a slide-topper noise-eliminating device that prevents the slide-topper fabric from being torn, and prevents the topper spring from being damaged in extremely windy conditions. Furthermore, there is a long felt need in the art for a slide-topper noise-eliminating device that does not require users to frequently repair or replace their slide-toppers, and therefore reduces vehicle maintenance expenses. Finally, there is a long felt need in the art for a slide-topper noise-eliminating device that can be easily installed onto the slide-topper of any conventional recreational vehicle and requires minimal set up.

The present invention, in one exemplary embodiment, is a novel slide-topper silencer device. The slide-topper silencer device comprises a folding hinge-like component and two friction slide clamps. The folding hinge-like component is secured to a lateral edge of the slide-topper by the two friction slide clamps. The folding hinge-like component also comprises pivotally-connected telescoping panels that secure the slide-topper between the panels, and wherein the telescoping panels can be extended or retracted to fit slide-toppers of various dimensions using the built-in telescoping slots.

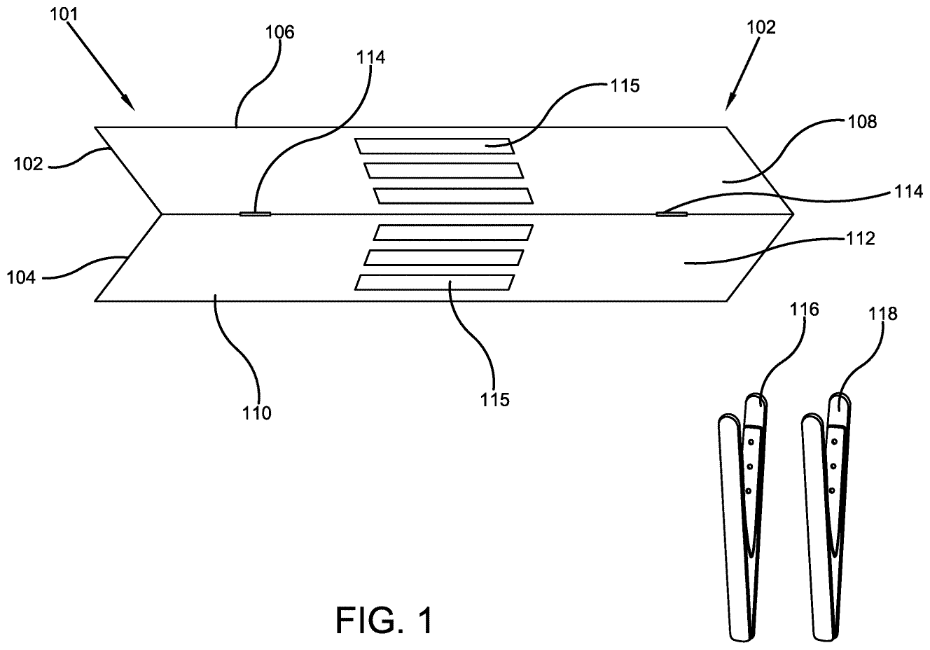

Referring initially to the drawings, FIG. 1 illustrates a front perspective view of one embodiment of a slide-topper anti-billowing device of the present invention. The slide-topper anti-billowing device 100 is configured to reduce the vibration and noise from movement and/or flapping of slide-toppers caused by high winds. Further, the device 100 protects slide-toppers from being torn off due to strong winds, and it eliminates flapping and/or lateral movement of the slide-topper material. The device 100 can be adjusted to fit onto the leading edge of slide-toppers of varying dimensions.

The device 100 comprises a folding hinge-like component 101 and a pair of side spring clamps 116, 118. The folding hinge-like component 101 is configured to secure around the leading (lateral) edges of a slide-topper using the side spring clamps 116, 118. The folded hinge-like component 101 comprises an upper panel 102 and a lower panel 104 and the panels 102, 104 are pivotally-connected together via at least one hinge component 114. The at least one hinge component 114 is typically a standard piano hinge but can be any suitable hinge as is known in the art. Typically, two hinge components 114 are used to pivotally secure the panels 102, 104 together, but any suitable number of hinge components 114 can be used as is known in the art.

The upper panel 102 and the lower panel 104 are configured to pivotally move relative to each other via hinge component 114. In an open position, the upper panel 102 and the lower panel 104 can be opened to a maximum of a ninety degree angle relative to each other. In a closed position, the upper panel 102 and the lower panel 104 can be closed such that the panels 102 and 104 touch or even adhere together, and/or overlap one another. Further, the side spring clamps 116, 118 are used for securing the upper panel 102 and the lower panel 104 together.

The upper panel 102 has an exterior surface 106 and an interior surface 108. The interior surface 108 contacts the top surface of the slide-topper (not shown) when the folding hinge-like component 101 is in use to protect the slide-topper. The interior surface 108 further comprises a plurality of rubber grips 115 which form a non-slip surface which acts to grip and secure the upper panel 102 to the slide-topper. Similarly, the lower panel 104 has an exterior surface 110 and an interior surface 112. The interior surface 112 touches the bottom surface of the slide-topper when the folding hinge-like component 101 is in use to protect the slide-topper. The interior surface 112 has a plurality of rubber grips 115 which form a non-slip surface which acts to grip and secure the lower panel 104 to the slide-topper. The folding hinge-like component 101 can be retrofitted for use with any conventional slide-topper to protect the slide-topper from strong winds. Further, the folding hinge component 101 does not crack, fade or peel when exposed to the elements. Further, the folding hinge-like component 101 features a ribbed design to allow for water drainage during storms.

The side spring clamps 116, 118 are used for securing the upper panel 102 and the lower panel 104 together, with the slide-topper positioned between the panels 102 and 104, thus preventing noise created due to flapping of the slide-topper in strong wind. The side spring clamps 116, 118 are typically manufactured from flexible plastic or aluminum, but can also be manufactured from any suitable material as is known in the art. The device 100 physically prevents a slide-topper from moving, flapping and/or billowing in windy conditions.

Preferably, the upper panel 102 and the lower panel 104 are of equal shape and size and are mirror images of each other. In use, the upper panel 102 and the lower panel 104 contact the top surface and the bottom surface of the slide-topper to prevent the slide-topper from moving, flapping, and/or billowing. Thus, the device 100 protects the aesthetic appearance and safety of the slide-topper.

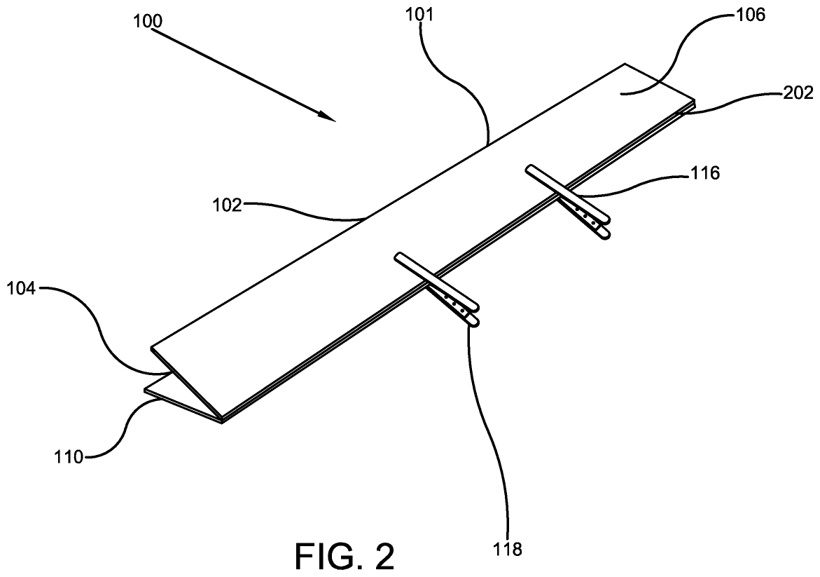

FIG. 2 illustrates a rear perspective view of one embodiment of the slide-topper anti-flapping device of the present invention. The upper panel 102 and the lower panel 104 of the folding hinge-like component 101 are hingedly-connected to each other via hinges (shown in FIG. 1 114) which are typically covered by an outer rubber covering 202. Further, a pair of side spring clamps 116, 118 are positioned along the length of the panels 102, 104 to secure the panels 102, 104 to the slide-topper. The side spring clamps 116, 118 are positioned on the exterior surface 106 of the upper panel 102 and the exterior surface 110 of the lower panel 104 of the folding hinge-like component 101 of the slide-topper anti-flapping device 100.

The hinge (shown in FIG. 1) of the folding hinge-like component 101 is designed to facilitate easy folding of the two panels 102, 104 to secure the slide-topper and prevent it from flapping, billowing and making noise. The device 100 also helps to maintain the aesthetic external appearance of the vehicle.

It should be noted that the present invention can be used to prevent flapping, banging and billowing of any awning. The flapping action of an awning, due to the passage of wind, can be very loud and disturbing and can prevent a person from sleeping, resting and/or concentrating. Use of the anti-flapping device 100 of the present invention, eliminates this flapping action and noise. Thus, the anti-flapping device 100 of the slide-topper prevents noise inside the vehicle and enhances the overall traveling experience for users.

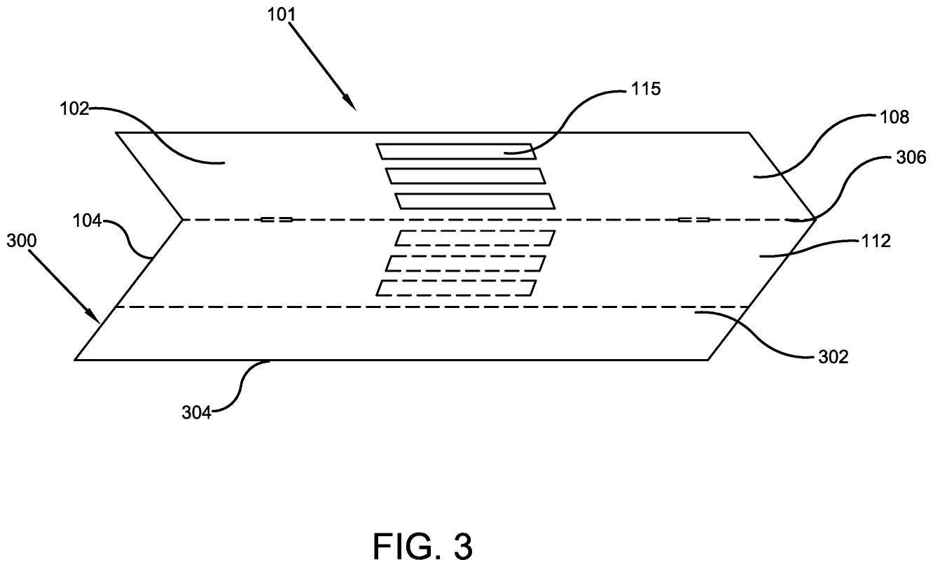

FIG. 3 illustrates a perspective view showing a slide-topper secured by the anti-flapping device of the present invention. Use of the present device 100 prevents flapping and eliminates noise created by a slide-topper or awning 300. Specifically, the interior surface 108 of the upper panel 102 and the interior surface 112 of the lower panel 104 are placed along a leading edge 306 of the slide-topper or awning 300. The interior surface 108 of the upper panel 102 is configured to adhere to the top surface 302 of the slide-topper 300 and the interior surface 112 of the lower panel 104 is configured to adhere to the bottom surface 304 of the slide-topper 300. Using the spring clamps (shown in FIG. 1), the upper panel 102 and the lower panel 104 are then secured and adhered around the leading edge 306 of the slide-topper 300. Further, the rubber grips 115 on the inside of the interior surfaces 108, 112 help to retain the folding hinge-like component 101 in place on the slide-topper 300.

The panels 102, 104 of the folding hinge-like component 101 are dimensioned to secure and fit onto slide-toppers 300 of various dimensions. The panels 102, 104 can be manufactured of metal, heavy duty plastic or aluminum or any other suitable material as is known in the art. Each panel 102, 104 is corrosion free, weatherproof and easily replaceable.

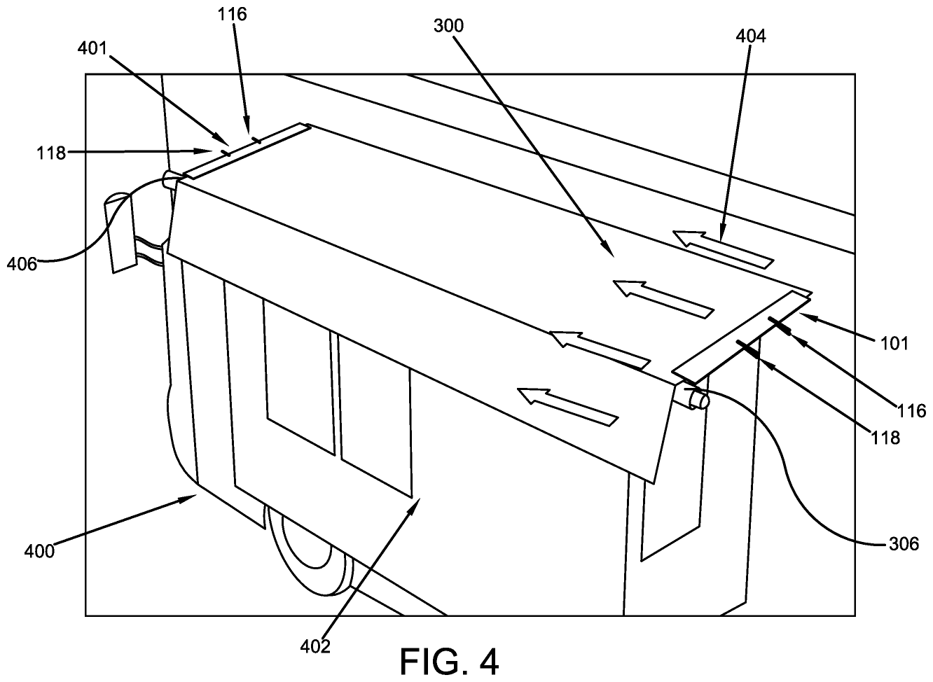

FIG. 4 illustrates a front perspective view disclosing installation of the anti-flapping device of the present invention on a slide-topper of a recreational vehicle. A folding hinge-like component 101 is secured to each leading edge 306, 406 of the slide-topper 300 which covers the roof of a slide out room 402 of a recreational vehicle 400. Each folding hinge-like component 101 is secured using a corresponding pair of side spring clamps 116, 118. The folding hinge-like component 101 when secured on an edge 306, 406 of the slide-topper 300, secures and stabilizes the edges 306, 406 of the slide-topper 300 and also prevents wind 404 from passing between the slide-topper 300 and the roof of the slide out room 402. Accordingly, the wind 404 passes above the slide-topper 300 which eliminates the flapping and movement of the slide-topper 300 onto the roof of the slide out room 402.

Further, the folding hinge-like component 101 eliminates the passage of wind 404 under the slide-topper 300 and thus the wind 404 is diverted to above and beside the slide-topper 300 to eliminate noise and movement of the slide-topper 300 and to prevent the slide-topper 300 from being torn off.

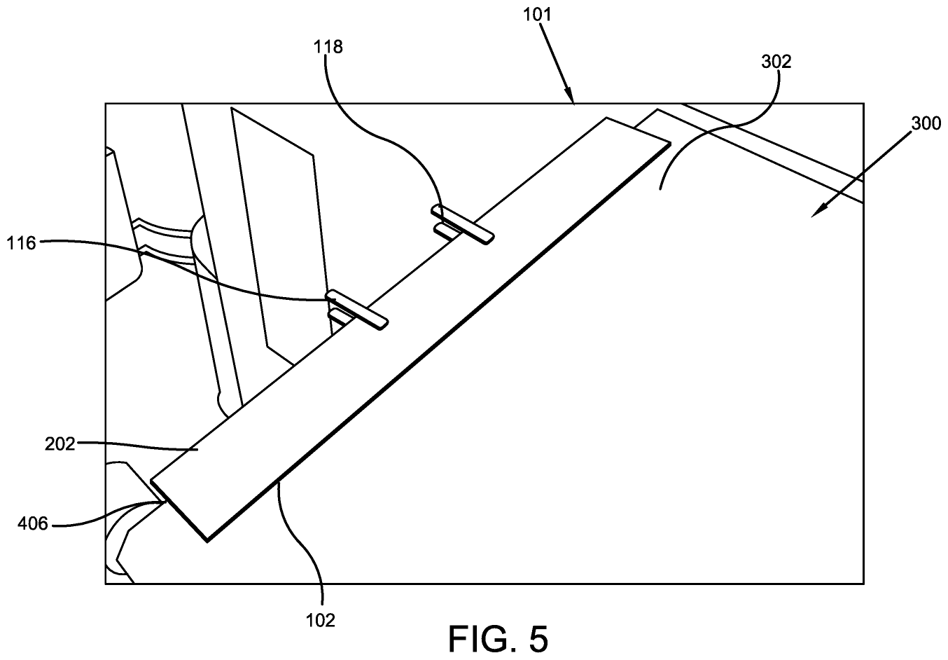

FIG. 5 illustrates a close-up view of the anti-flapping device installed along a leading edge of the slide-topper. The upper panel 102 adheres to the top surface 302 of the slide-topper 300 wherein the folding hinge-like component 101 is secured along the edge 406 of the slide-topper 300. The side spring clamps 116, 118 are used for securing the folding hinge-like component 101 to the edge 406 of the slide-topper 300 to eliminate the flapping and noise created due to wind. The folding hinge-like component 101 secures and stabilizes the edge 406 of the slide-topper 300 in strong wind conditions, and eliminates movement of the slide-topper 300.

The anti-flapping device for slide-toppers and awnings of the present invention effectively protects a slide-topper/awning from material tearing and risk of the slide-topper tearing from the side of the vehicle/slide out room. The device also reduces wear and tear of the slide-topper spring as it eliminates the extreme force applied on the spring due to strong wind.

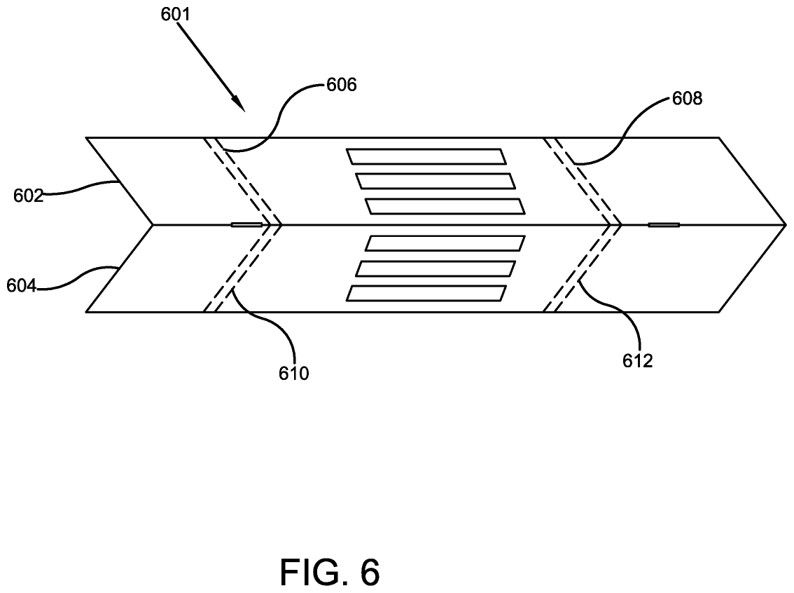

FIG. 6 illustrates a perspective view of another embodiment of the folding hinge-like component of the anti-flapping device. In the present embodiment, the upper panel 602 and the lower panel 604 of the folding hinge-like component 601 are telescopic in length. Specifically, the upper panel 602 has telescoping slots 606, 608 and the lower panel 604 has telescoping slots 610, 612 for extending or retracting the length of the panels 602, 604 to fit the folding hinge-like component 601 to the leading edges of the slide-topper. Thus, the length of the panels 602, 604 can be customized by extending or retracting the telescoping slots of the folding hinge-like component 601.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “slide-topper anti-flapping device”, “slide-topper anti-billowing device”, “anti-flapping device”, “slide-topper silencer”, “device”, and “kit”, are interchangeable and refer to the slide-topper anti-flapping device 100 of the present invention.

Notwithstanding the forgoing, the slide-topper anti-flapping device 100 of the present invention can be of any suitable size and configuration as is known in the art without affecting the overall concept of the invention, provided that it accomplishes the above-stated objectives. One of ordinary skill in the art will appreciate that the size, configuration, and material of the slide-topper anti-flapping device 100 as shown in FIGS. 1-6 is for illustrative purposes only, and that many other sizes and shapes of the slide-topper anti-flapping device 100 are well within the scope of the present disclosure. Although the dimensions of the slide-topper anti-flapping device 100 are important design parameters for user convenience, the slide-topper anti-flapping device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A slide-topper anti-flapping device for reducing a vibration and a noise from a slide-topper, the slide-topper anti-flapping device comprising:
a folding hinge-like component; and
a pair of side spring clamps, wherein the folding hinge-like component is configured to secure around a leading edge of the slide-topper, and further wherein the pair of side spring clamps secure the folding hinge-like component to the slide-topper.

2. The slide-topper anti-flapping device of claim 1, wherein the folding hinge-like component comprises an upper panel and a lower panel secured together.

3. The slide-topper anti-flapping device of claim 2, wherein the upper panel and the lower panel are secured together by at least one hinge component.

4. The slide-topper anti-flapping device of claim 2, wherein the upper panel and the lower panel are secured together by at least two hinge components.

5. The slide-topper anti-flapping device of claim 4, wherein the at least two hinge components are piano hinges.

6. The slide-topper anti-flapping device of claim 5, wherein the upper panel and the lower panel are configured to pivot relative to each other.

7. The slide-topper anti-flapping device of claim 6, wherein in an open position, the upper panel and the lower panel are opened to a maximum of a ninety degree angle relative to each other.

8. The slide-topper anti-flapping device of claim 7, wherein in a closed position, the upper panel and the lower panel are closed such that the upper panel and the lower panel touch each other.

9. The slide-topper anti-flapping device of claim 8, wherein the upper panel comprises an exterior surface and an interior surface, and the interior surface contacts a top surface of the slide-topper.

10. The slide-topper anti-flapping device of claim 9, wherein the lower panel comprises an exterior surface and an interior surface, and the interior surface contacts a bottom surface of the slide-topper.

11. The slide-topper anti-flapping device of claim 10, wherein the interior surface of the upper panel and the interior surface of the bottom panel comprise a plurality of rubber grips which form a non-slip surface.

12. The slide-topper anti-flapping device of claim 11, wherein the folding hinge-like component comprises a ribbed design to facilitate water drainage.

13. A slide-topper anti-flapping device for reducing a vibration and a noise from a slide-topper, the slide-topper anti-flapping device comprising:
a folding hinge-like component comprising an upper panel and a lower panel secured together by at least one hinge component; and
a pair of side spring clamps; and
wherein the folding hinge-like component is configured to secure around a leading edge of a slide-topper;
wherein the pair of side spring clamps secure the folding hinge-like component to the slide-topper; and
further wherein the upper panel and the lower panel are configured to pivot relative to each other, such that in an open position, the upper panel and the lower panel are opened to a maximum of a ninety degree angle relative to each other; and in a closed position, the upper panel and the lower panel are closed such that the upper panel and the lower panel touch each other.

14. The slide-topper anti-flapping device of claim 13, wherein the upper panel comprises an exterior surface and an interior surface, and the interior surface contacts a top surface of the slide-topper.

15. The slide-topper anti-flapping device of claim 14, wherein the lower panel comprises an exterior surface and an interior surface, and the interior surface contacts a bottom surface of the slide-topper.

16. The slide-topper anti-flapping device of claim 15, wherein the interior surface of the upper panel and the interior surface of the bottom panel comprise a plurality of rubber grips which form a non-slip surface.

17. The slide-topper anti-flapping device of claim 16, wherein the folding hinge-like component comprises a ribbed design for water drainage.

18. A slide-topper anti-flapping device for reducing a vibration and a noise from a slide-topper, the slide-topper anti-flapping device comprising:
a folding hinge-like component comprising an upper panel and a lower panel secured together by at least one hinge component; and
a pair of side spring clamps; and
wherein the folding hinge-like component is configured to secure around a leading edge of a slide-topper;
wherein the pair of side spring clamps secure the folding hinge-like component to the slide-topper; and
further wherein the upper panel and the lower panel are telescopic in length and can be adjusted to accommodate slide-toppers of varying dimensions.

19. The slide-topper anti-flapping device of claim 18, wherein the upper panel comprises a plurality of telescoping slots and the lower panel comprises a plurality of telescoping slots.

20. The slide-topper anti-flapping device of claim 19, wherein the plurality of telescoping slots in the upper panel and the lower panel allow for extending or retracting the upper and the lower panels to secure the folding hinge-like component to the leading edge of the slide-topper.
